(19) United States
(12) Patent Application Publication
(10) Pub. No.: US 2015/0150236 A1
(43) Pub. Date: Jun. 4, 2015

(54) MULTIPLE-USE VERMIN TRAP APPARATUS, METHOD AND SYSTEM

(71) Applicant: John Grant, Calgary (CA)

(72) Inventor: John Grant, Calgary (CA)

(73) Assignee: Animal Deterrent System Ltd., Calgary, AB (CA)

(21) Appl. No.: 14/403,039

(22) PCT Filed: May 29, 2012
(86) PCT No.: PCT/CA2012/000518

§ 371 Date: Nov. 21, 2014

(51) Int. Cl. A01M 23/38; A01M 23/14; A01M 23/10

(52) U.S. Cl. CPC A01M 23/38; A01M 23/10; A01M 23/14

(57) ABSTRACT

A vermin trap including a rotatable passage, the passage comprising an electrocution section and an open section, and a sensor for detecting vermin presence in the passage. When a vermin detection signal is sent to a controller, the controller causes electrification of the electrocution section and electrocution of the vermin, and the controller subsequently rotates the passage such that the vermin carcass is dumped downwardly through the open section. A method of using the vermin trap is disclosed, as is a system for indicating trap status and transmitting status indicators.

### FIELD OF THE INVENTION

The present invention relates to animal traps, and more particularly to electric vermin traps.

### BACKGROUND OF THE INVENTION

Native to central Asia, mice arrived in North America with settlers from Europe and other points. Rats arrived in similar fashion. The rodents spread across North America and are now found in every province and territory in Canada, and every state in the United States. This includes all major population areas.

Mice are considered among the most troublesome and economically damaging rodents in North America. Rats are also a very serious problem, but because the general population does not usually come into regular contact with rats, rats are not perceived to be as significant a problem as mice. However, both mice and rats are very adaptable and able to live in close association with humans; as such, both are termed “commensal” rodents. Mice are much more common in residences and structures than other common rodents, including shrews, voles and squirrels. The focus is on rodents including mice and rats for purposes of the present application, but the present invention is equally relevant and appplicable to other pests, including, without limitation voles, squirrels and other pests. The term “vermin” is often used herein, and is used in a non-limiting sense, being merely representative of the great variety of rodents and other pests that someone of ordinary skill in the art would easily recognize as being proper targets of the trap and method taught herein.

Mice live in and around homes, farms, commercial establishments, in open fields and meadows. With the onset of cold weather each fall, mice move into structures in search of shelter and food. Mice can survive with little or no free water, although they will readily drink if water is available. They can obtain all the water they need from the food they eat. An absence of free water, or food with low moisture content in their environment, may reduce their breeding potential.

Mice have poor eyesight, relying on their hearing and highly developed senses of smell, taste, and touch. Mice breed year round, but when living outdoors, they usually breed in spring and fall. A female may have five to ten litters of four to eight young per year, and the gestation period is 18 to 21 days. A female is sexually mature at six to eight weeks of age. Mouse populations can, therefore, increase rapidly under good conditions, and the average mouse lives one to two years.

Rodents can transmit various diseases to humans, including salmonellosis (food poisoning), rickettsialpox, and lymphocytic choriomeningitis. Mice may carry leptospirosis, rat bite fever, tapeworms, and organisms that may cause ringworm (a fungal disease of the skin) in humans. As well, mice may carry hantavirus pulmonary syndrome (“Hantavirus”), which can be lethal to humans. In addition, rodents can chew through protective covering on wires causing major damage in commercial and industrial complexes. Accordingly, rodents should not be tolerated around schools, restaurants, food storage areas, warehouses, office buildings, dwellings or other areas where humans may come into contact with rodents or the organisms they carry. The Food and Agricultural Organization of the United Nations reported that between one-fifth and one-third of the world's total food supply never reaches the table due to losses from rodents.

Damage, to insulation inside walls and attics, quickly occurs when mice reach large populations in dwellings and commercial buildings. They may gnaw electrical wiring and create tire hazards or other malfunctions that are expensive to repair.

Various control methods are currently employed, with varying degrees of effectiveness. Poison baits are commonly employed, but they should never be used when there may be children or other animals present. Further, this method also suffers from the fact that mice usually return to their nest in an inaccessible location prior to death. Even if they do not return to their nest, mice perishing within walls or other inaccessible places within a dwelling or commercial building can cause secondary infestations of damaging insects that feed and breed upon the carcasses. Mice will also hoard or carry food to other locations; such hoarding of food is common, and it may result in amounts of poison bait being moved to places where it goes undetected and may be hazardous to non-target species. Non-toxic methods of rodent control are more effective and considerably more sanitary since rodents captured by these methods can be disposed of properly.

Trapping is one alternative method of controlling mice, but it requires labour, time and handling of any captured mice. One advantage is that it eliminates the problem of odours from decomposing carcasses and secondary infestations that may occur when poisoning is used. It also has the advantage of not relying on inherently hazardous rodenticides, it permits the user to view his or her success, and it allows for easier disposal of the mice. However, the success raw for traps varies widely and the method still requires the physical handling of mice, with all the inherent dangers of the diseases mentioned above being transmitted to humans—and particularly Hantavirus.

So-called “snap traps” are simple and inexpensive; however, the quality and effectiveness varies widely. Some poorly made snap traps will often break when they are triggered, are ineffective due to flaws, or are not sensitive enough to catch small or cautious mice.

An alternative to snap traps are glue boards, which catch mice by means of a pressure sensitive adhesive. When mice attempt to cross the glue board, they get stuck, much the same way that flypaper catches flies. A significant drawback to glue boards is that the mouse is not killed (but will die from starvation and dehydration if not attended) and must be killed and then disposed of. Because the mouse is not killed, many jurisdictions have banned glue boards.

Box traps work on the principle that mice readily enter small holes. The traps then hold the mice by means of one-way doors. More than one mouse may be caught by these traps, but because the mice are only caught and not killed, someone needs to check the traps frequently and release the captured mice. Of coarse, they will need to be released some distance, normally at least one kilometer, from the dwelling or commercial building or they will simply return and enter. And, again, all the hazards are present of the mice transmitting the various diseases to the persons handling the trap.

Several styles of electrocution traps have become available in recent years. Most are powered by batteries and produce death to rodents by delivering a high volt-low amperage jolt. These traps potentially offer a quick, easy and less messy means of removing rodents when compared to either snap traps or glue boards. However, their reliability varies greatly and there are reports that some rodents are capable of escaping lethal encounters with some models. All of them presently require someone to physically handle the dead rodents to dispose of them. Again, the possibility of disease being transmitted from the dead rodents is present.

Many electrocution traps are unnecessarily complicated and costly, with the result that they have not met with general positive reaction from consumers. Also, they are often not designed in such a way that cautious vermin can be successfully trapped; mice in particular need to be presented with a simple pathway, configured such that it can be positioned preferably close to a wall. Furthermore, most traps do not provide a timely indication of a trap being tripped, and it is therefore more likely that carcasses will accumulate and decompose in the trap, and possibly also deter subsequent mice from entering the trap.

What is needed, therefore, is a trap that is simple and effective, attracting naturally cautious vermin and providing for safe handling of the dead catch, and preferably incorporates means to indicate that the trap has been tripped.

### SUMMARY OF THE INVENTION

The present invention accordingly seeks to provide a trap, trapping method and system that is applicable to a number of rodent and pest types, for example, but not limited to rats, mice and the like. Further, the present invention seeks to provide a trap and method which is simple, effective, aid safe to use.

According to a first aspect of the present invention there is provided a vermin electrocution trap apparatus comprising:
a housing comprising an interior path, the path comprising an in-line rotatable passage rotatable between a vermin electrocution position and a vermin discarding position;
ingress means in the housing to enable vermin access to the path;
bait retention means adapted to receive bait, the bait retention means spaced from the ingress means so as to attract vermin to proceed along the path to the passage;
the passage comprising an electrocution surface spaced apart from an opening, such that the electrocution surface is disposed downwardly when the passage is in the vermin electrocution position and the opening is disposed downwardly when the passage is in the vermin discarding position, the electrocution surface comprising one or more areas wired for passage of electrical current;
a carcass disposal region disposed below the passage; and
sensor means (preferably but not necessarily an infrared beam) adjacent the electrocution surface and adapted to detect presence of vermin and send a vermin detection signal to a control means upon detecting presence of the vermin;
the control means adapted to (i) electrify the electrocution surface in response to receiving the vermin detection signal so that electrical current is passed through the vermin to kill the vermin, and (ii) subsequently actuate rotation of the passage from the vermin electrocution position to the vermin discarding position to drop the vermin through the opening into the carcass disposal region.

According to a second aspect of the present invention there is provided a method of entrapping and electrocuting vermin, the method comprising the steps of:
a. providing the vermin electrocution trap apparatus of the first aspect of the present invention, activating the apparatus, and inserting bait in the bait retention means;
b. attracting the vermin to the apparatus using the bait;
c. allowing the vermin to enter the path;
d. allowing the vermin to proceed into the passage;
e. sensing the vermin using the sensor means;
f. sending the vermin detection signal to the control means upon sensing the vermin;
g. transmitting electrical current to the electrocution surface to electrocute the vermin;
h. rotating the passage to the vermin discarding position; and
i. allowing the vermin to fall downwardly through the opening into the carcass disposal region.

According to a third aspect of the present invention there is a provided a system for trapping and electrocuting vermin, the system comprising:
the vermin, electrocution trap apparatus of the first aspect of the present invention;
the sensor means configured to send a vermin presence signal;
the control means being operative to receive the vermin presence signal; and
the control means being further operative to allow transmission of electrical current to the electrocution surface and cause rotation of the passage to the vermin discarding position, in response to receiving the vermin presence signal.

In exemplary embodiments of the present invention the apparatus comprises a one-way door adjacent the passage, such that access to the passage requires the vermin to pass through the one-way door. In further embodiments, the path comprises two ramps extending from opposed ends of the passage, each such ramp adjacent a one-way door allowing vermin access to the passage. The bait retention means are preferably disposed above the passage to attract the vermin toward the passage, and preferably comprise vents to disperse bait scent into the passage. Where one-way doors are employed, such doors are preferably also provided with vents to allow the bait scent to disperse along the path and attract the vermin toward the passage. A removable liner is preferably provided within the carcass disposal region to receive vermin carcasses after electrocution and thereby enabling safe and efficient disposal of the vermin carcasses. It also ensures that there is no scent retention of dead vermin that might possibly deter other vermin from entering.

In further exemplary embodiments of the present invention, the present invention comprises external apparatus status indicators and/or wireless communication to enable remote monitoring. For example, the control means may be enabled to communicate with external status indicator lights on the outside of the housing, which lights can indicate the status of the apparatus power level, whether the trap has caught a vermin, whether the power is on or off, and/or whether wireless communication signals are enabled. In the case of wireless communication, the present invention can comprise wireless communication that can allow the control means to communicate with a remote monitoring location as to the status of the apparatus and whether the trap has been activated, thereby reducing the amount of on-site trap servicing that is required.

A detailed description of an exemplary embodiment of the present invention is given in the following. It is to be understood, however, that the invention is not to be construed as being limited to this embodiment.

### BRIEF DESCRIPTION OF THE DRAWINGS

In the accompanying drawings, which illustrate an exemplary embodiment of the present invention:

FIG. 1 is a front perspective of an apparatus accordance with the present invention;

FIG. 2 is a front perspective view of the apparatus of FIG. 1 from a different angle;

FIGS. 3a-c are perspective views of the rotatable passage seen in FIG. 1;

FIG. 4 is a rear perspective view of the apparatus of FIG. 1;

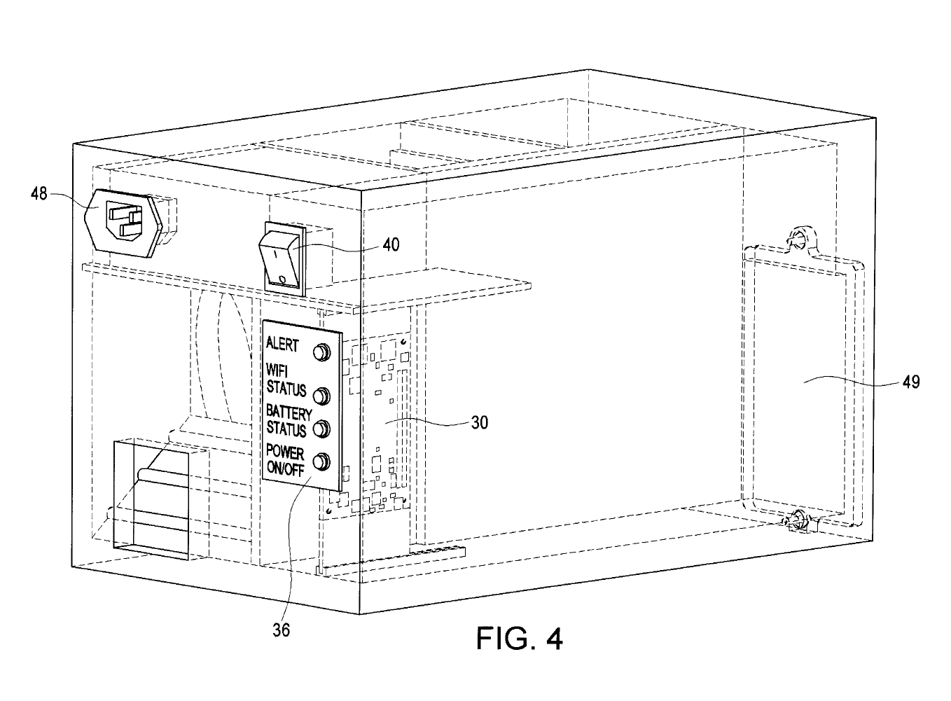

FIGS. 5a-f are views of a passage according to the apparatus of FIG. 1 with one-way doors and motor;

FIG. 6 is a flowchart illustrating an exemplary method according to the present invention; and

FIG. 7 is a simplified illustration of an exemplary system according to the present invention.

A preferred embodiment of the present invention will now be described with reference to the accompanying drawings.

### DETAILED DESCRIPTION OF EXEMPLARY EMBODIMENTS

Referring now to the accompanying drawings, an embodiment of a vermin trap according to the present invention is illustrated.

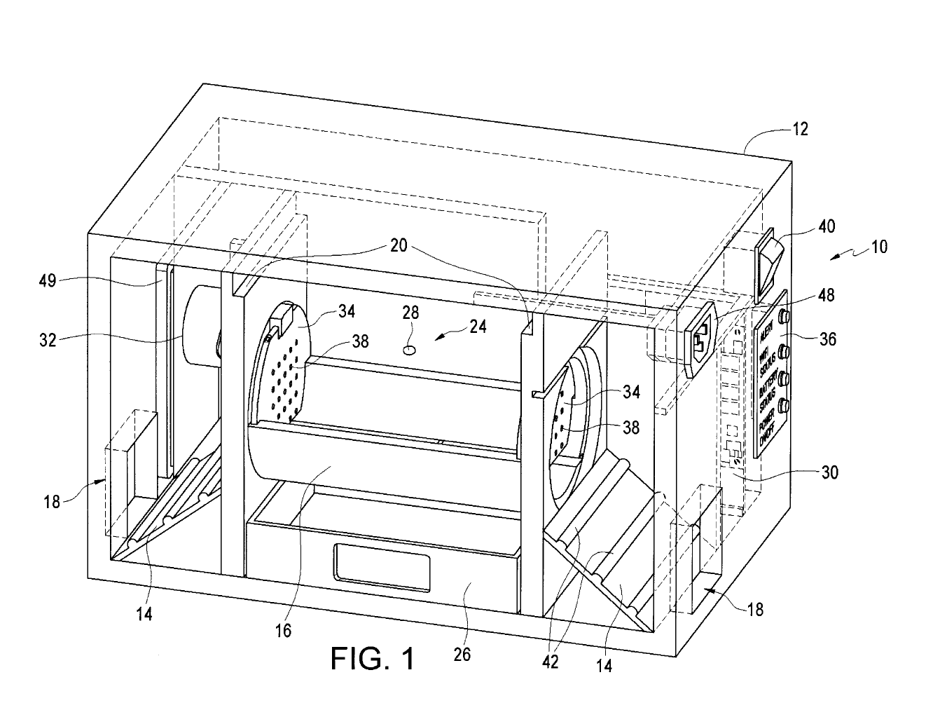

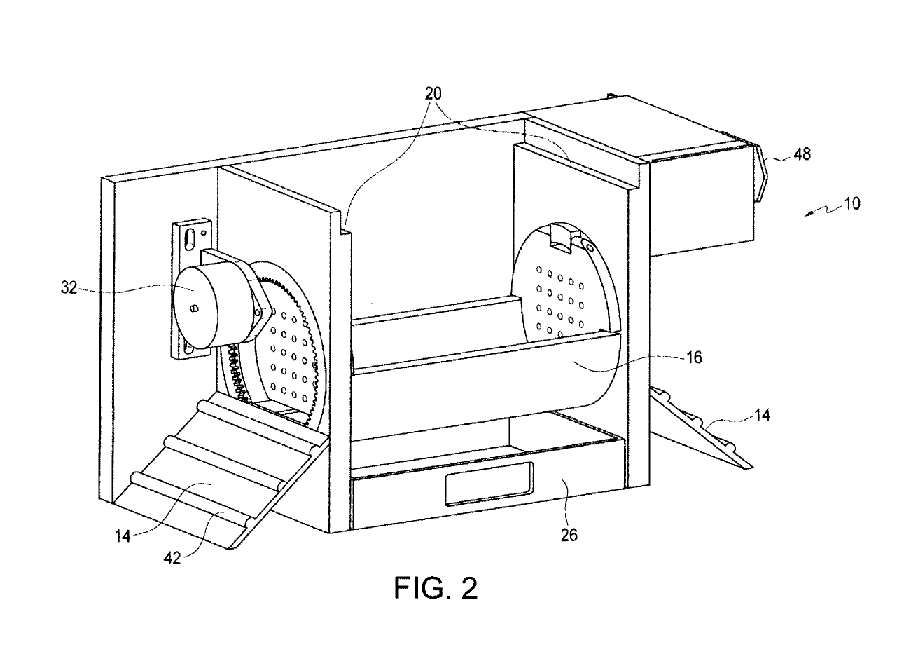

Referring now in detail to FIGS. 1 and 2, a trap apparatus 10 according to the present invention is illustrated. The apparatus 10 comprises a housing 12 which incorporates two open entrances 18 and contains an interior path. The interior path in the illustrated embodiment consists of opposed ramps 14 and a rotatable passage 16 therebetween, such that vermin can enter the housing 12 from either entrance 18 and pass up one of the ramps 14 to the passage 16. The ramps are provided with ribs 42 to provide enhanced traction for the vermin. Bait retention means 20 are provided directly above the passage 16 and comprise ledges on which a bait tray can be positioned, with bait inserted therein; the bait tray can be provided with ventilation holes to help ensure adequate dispersal of the bait scent, as would be obvious to one skilled in the art. It is to be noted that the entrances 18, ramps 14 and passage 16 are aligned in a straight line that is off-set from the apparatus 10 centre; this is so that the path can be positioned dose to a wall and provide a straightforward tunnel for vermin. Given that vermin, especially mice, are naturally cautious and would be generally hesitant to enter a path that was spaced from a wall or provided a meandering or convoluted passageway, this configuration will provide a more attractive passageway for the vermin that have caught the scent of the bait.

The ramps 14 lead upwardly toward the passage 16, such that a carcass disposal region can be disposed underneath the passage 16. In the illustrated embodiment, the carcass disposal region comprises as carcass disposal drawer 26, which can be provided with a disposable plastic liner as would be obvious to one skilled in the art. As described below, the drawer 26 will receive the electrocuted carcass of the vermin and store same pending removal from the apparatus 10.

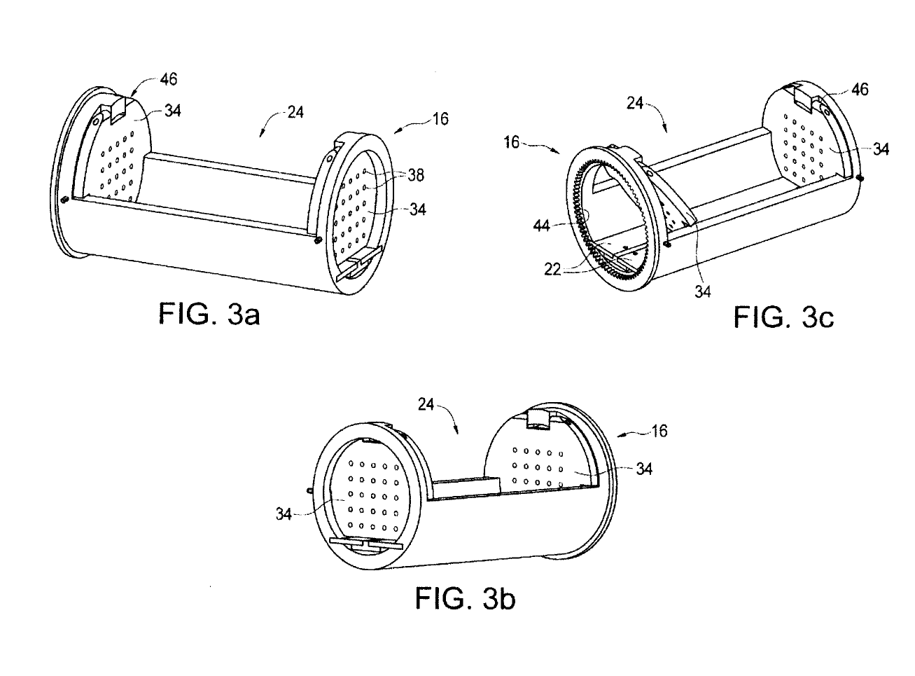

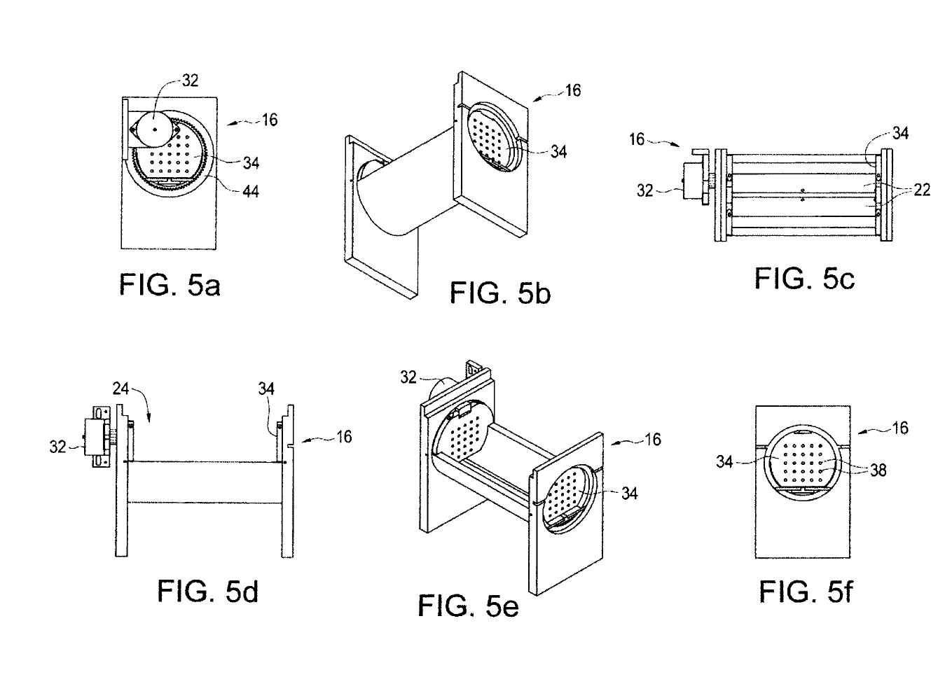

The rotatable passage 16 comprises two opposed one-way doors 34, including door vents 38 to enable enhanced dispersal of bait scent along the path. The passage 16 is illustrated in detail in FIGS. 3a to 3c and 5a to 5f and it functions to capture the vermin, allow its electrocution, and dispose of the carcass. To enable the capture of the vermin, the one-way doors 34 are hinged at hinge 46 so that they swing inwardly when pushed against by the vermin seeking access to the passage 16 (as can best be seen in FIG. 3c); however, the doors 34 are set into a frame that blocks the ability to swing the doors 34 outwardly, so that upon entering the passage 16 the vermin is effectively held in place between the two doors 34. Obviously, the passage 16 itself must be of sufficient length to allow for a vermin to pass fully through one of the doors 34 and allow it to close behind.

An electrocution surface 22, which in the illustrated embodiment is a pair of metal strips, is provided on the inner surface of the passage 16. As can best be seen in FIGS. 3c and 5c, the electrocution surface 22 extends the length of the passage 16 from one door 34 to the other door 34; in this way it is far less likely that the vermin can find some way to avoid the electrocution functionality of the apparatus 10.

Directly opposite the electrocution surface 22 is an opening 24 in the passage 16. The opening 24 runs the length of the passage 16 and is normally disposed upwardly, as illustrated in FIG. 1, with the opposed electrocution surface 22 disposed downwardly so that the vermin will step onto the electrocution surface 22 (the vermin electrocution position). However, the apparatus 10 is provided with a motor 32 adjacent the passage 16, which motor 32 engages a geared end 44 of the passage 16. The motor 32 comprises a round gear (not shown) that engages the teeth of the geared end 44 (essentially a ring gear), such that when the motor 32 is actuated the round gear rotates and thereby causes the passage 16 to rotate. What this accomplishes is to reverse the disposition of the electrocution surface 22 and the opening 24, such that the former is disposed upwardly and the latter is disposed downwardly toward the carcass disposal drawer 26 (the vermin discarding position). Vermin that have been electrocuted when the passage 16 is in the vermin electrocution position can then be dumped into the drawer 26 when the passage 16 is rotated by means of the motor 32 into the vermin discarding position.

The apparatus is further provided with sensor means 28 adapted to detect the presence of vermin within the confines of the passage 16 and send a signal to control means 30. The control means 30 include standard processing means and circuitry/electronics and related wiring, and would be simple to construct based on the disclosure within. The sensor means 28 are preferably a combination infrared beam and heat sensor that is tripped when the vermin breaks the beam upon reaching the mid-point of the passage 16. Once tripped, the sensor means 28 send a vermin detection signal to the control means 30, and the control means 30 then allows the electrification of the electrocution surface 22 (preferably at 8000 volts), thereby quickly electrocuting the vermin. The electrical current required tier the electrocution is preferably provided by a single lithium-ion battery with a 3.7 nominal cell voltage, with a transformer and high voltage circuit to provide the desired 8000 volts; alternatively, the trap could use six D cell rechargeable batteries (which can be inserted using battery access door 49), which can be recharged through the receptacle 48 shown in FIG. 1 and related wiring (or, alternatively, the batteries can be replaced with fresh charged batteries and the depicted batteries recharged at a remote location); as a further alternative, the receptacle 48 may be configured in a conventional manner to provide direct power to allow the electrocution. The control means 30 then cause the motor 32 to rotate the passage 16 such that the opening 24 is disposed downwardly, thereby allowing the electrocuted vermin to fall through the opening 24 into the drawer 26. The passage 16 is then rotated back to the original position, awaiting the next vermin entry.

The apparatus is further provided with indicator lights 36, which can be designed to provide a visual indication of various apparatus systems through communication with the control means 30. In the illustrated embodiment of FIG. 1, the indicator lights 36 indicate trap activation, wifi status, battery status and power on/off. The apparatus is further provided with a power on/off switch 40.

It is also preferred that exemplary embodiments of the present invention comprise means to wirelessly communicate certain status information to a remote monitoring location, as is described below. To enable this, the control means 30 would further comprise wireless communication means such as a modem and related electronics.

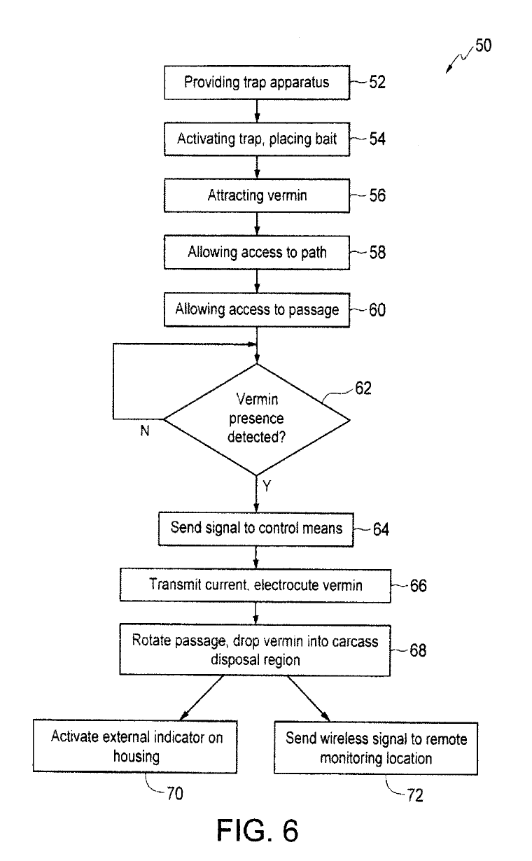

Turning now to FIG. 6, an exemplary method 50 according to the present invention is illustrated. A trap apparatus is provided in accordance with the present invention at step 52, and the trap is then powered up and provided with bait at step 54. The next three steps 56, 58, 60 are passive, as the user allows the bait scent to attract the vermin through the path to the rotatable passage. At this point the method 50 includes a detection step 62 using the sensor means, such that detection continues (in the event of a “no” determination) or the vermin has been trapped (in the event of a “yes” determination). If the sensor means determines that a vermin has been trapped, it sends a signal at step 64 to the control means indicating that the trap has been tripped. Upon receipt of this detection signal, the control means allow for the transmission of electrical current to the electrocution surface and the resultant electrocution of the vermin at step 66.

Once the vermin has been electrocuted, the control means signal the motor to rotate the passage to the vermin discarding position, allowing the carcass to fall through the opening into the drawer at step 68 (with the control means then signalling the motor, after a set time interval, to return the passage to its original position). At this point, the method 50 comprises two further steps (which may occur in series or simultaneously) by the control means, namely signaling the external indicator lights that the trap has been tripped at step 70 and sending a wireless signal to a remote monitoring location at step 72. The signal to the wireless monitoring location preferably includes both an indication that the trap has been tripped and also its location, enabling a focused and efficient servicing of whatever traps are on the system.

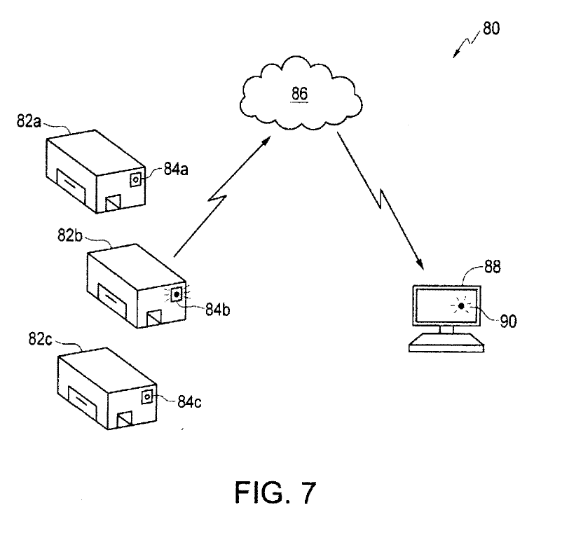

Turning finally to FIG. 7, a simplified schematic illustration is provided of an exemplary system 80 in accordance with the present invention. It is believed that the determination of appropriate specific hardware for implementing the present invention is within the common general knowledge of one skilled in the art. Also, any software development necessary for implementation of the present invention is considered to be within the common general knowledge of one skilled in the art of programming not requiring any unusual effort or experimentation to generate beyond the disclosure herein. It is therefore believed that the below description is sufficiently enabling for one skilled in the relevant art, and few further details of exemplary hardware or software will be provided herein.

In the system 80 of FIG. 7, three traps 82 are set at different locations where the user wishes to trap vermin. As described above, the traps 82 are provided with bait and powered on, including enabling wireless communication when initiated by the control means. The system 80 would normally be quiescent until tripped by a vermin. In the illustrated example, traps 82a and 82c remain untouched, but a vermin enters trap 82b and is electrocuted. The external indicator light 84b is directed by the control means for trap 82b to indicate trap activation, represented by the flashing indicator light in FIG. 7. At this paint, or concurrently with the signal to the indicator light, the control means sends a signal by means of wireless communication capability through the communication network 86 to the remote monitoring location 88. Upon receipt of the signal at the remote monitoring location 88, a signal 90 is displayed indicating the location and status of trap 82b. A user can then dispatch personnel to that location to confirm that vermin has been captured and empty the drawer of any carcasses. The control means of the trap 82b can then be re-set (either automatically, manually or remotely, as would be obvious to one skilled in the art) to enable subsequent vermin trapping/electrocution events.

As can be readily seen, then, the vermin trap of the present invention presents significant advantages over the prior art. Whereas many prior art electrocution traps are complicated in design and layout, the simplified path of the present invention, positionable near a wall, is far more attractive to naturally cautious vermin such as mice. The remote monitoring functionality reduces labour, time and handling, and timely notification allows for removal of carcasses before they decompose and become a deterrent to further captures. Vermin are confined within the passage, with a simple rotation of the passage allowing disposal of the carcass, and the use of a drawer with a disposable liner helps reduce the risk of disease transmission. Finally, the very simple construction compared with other electrocution traps has the advantage of being less costly to manufacture.

The foregoing is considered as illustrative only of the principles of the invention. Thus, while certain aspects and embodiments of the invention have been described, these have been presented by way of example only and are not intended to limit the scope of the invention. Indeed, the invention described herein may be embodied in a variety of other forms without departing from the spirit of the invention, which invention is defined solely by the claims below.

1. A vermin electrocution trap apparatus comprising:
a housing comprising an interior path, the path comprising an in-line rotatable passage rotatable between a vermin electrocution position and a vermin discarding position;
ingress means in the housing to enable vermin access to the path;
bait retention means adapted to receive bait, the bait retention means spaced from the ingress means so as to attract vermin to proceed along the path to the passage;
the passage comprising an electrocution surface spaced apart from an opening, such that the electrocution surface is disposed upwardly when the passage is in the vermin electrocution position and the opening is disposed downwardly when the passage is in the vermin discarding position, the electrocution surface comprising one or more areas wired for passage of electrical current;
a carcass disposal region disposed below the passage; and
sensor means adjacent the electrocution surface and adapted to detect presence of vermin and send a vermin detection signal to a control means upon detecting presence of the vermin;
the control means adapted to (i) electrify the electrocution surface in response to receiving the vermin detection signal so that electrical current is passed through the vermin to kill the vermin, and (ii)) subsequently actuate rotation of the passage from the vermin electrocution position to the vermin discarding position to drop the vermin through the opening into the carcass disposal region.

2. The apparatus of claim 1 further comprising a one-way door adjacent the passage, such that access to the passage requires the vermin to pass through the one-way door.

3. The apparatus of claim 1 wherein the sensor means comprises an infrared beam.

4. The apparatus of claim 1 wherein the control means communicates via external status indicator lights to indicate status of the apparatus.

5. The apparatus of claim 1 wherein the path comprises two ramps extending from opposed ends of the passage, each such ramp adjacent a one-way door allowing vermin access to the passage.

6. The apparatus of claim 1 wherein the bait retention means is disposed above the passage and comprises vents to allow dispersal of bait scent.

7. The apparatus of claim 2 wherein the one-way door is provided with vents to allow dispersal of bait scent.

8. The apparatus of claim 1 further comprising a removable liner within the carcass disposal region that is adapted to receive vermin carcasses after electrocution and enabling disposal of the vermin carcasses.

9. The apparatus of claim 1 further comprising wireless communication means to allow the control means to transmit a signal to a remote location providing one or more of an apparatus power indicator and an apparatus activation indicator.

10. A method for entrapping and electrocuting vermin which comprises:
a. providing the vermin electrocution trap apparatus of claim 1, activating the apparatus, and inserting bait in the bait retention means;
b. attracting the vermin to the apparatus using the bait;
c. allowing the vermin to enter the path;
d. allowing the vermin to proceed into the passage;
e. sensing the vermin using the sensor means;
f. sending the vermin detection signal to the control means upon sensing the vermin;
g. transmitting electrical current to the electrocution surface to electrocute the vermin;
h. rotating the passage to the vermin discarding position; and
i. allowing the vermin to fall downwardly through the opening into the carcass disposal region.

11. The method of claim 10 which further comprises:
providing the apparatus with wireless communication means; and
allowing the control means to transmit a signal to a remote location using the wireless communication means, the signal providing one or more of an apparatus power indicator and an apparatus activation indicator.

12. A system for entrapping and electrocuting vermin, the system comprising:
the vermin electrocution trap apparatus of claim 1;
the sensor means configured to send a vermin presence signal;
the control means being operative to receive the vermin presence signal; and
the control means being further operative to allow transmission of electrical current to the electrocution surface and cause rotation of the passage to the vermin discarding position, in response to receiving the vermin presence signal.

13. The system of claim 12 wherein:
the control means is connected to external display means on the housing; and
the control means is configured to send a signal to the external display means providing one or more of an apparatus power indicator and an apparatus activation indicator.

14. The system of claim 12 wherein the control means is connected to a communication network and configured to allow wireless communication of signals.

15. The system of claim 14 wherein the control means is configured to send wireless signals providing one or more of an apparatus power indicator and an apparatus activation indicator to a remote monitoring location.

16. A vermin electrocution trap apparatus comprising:
a housing comprising an interior path, the path comprising an in-line rotatable passage rotatable between a vermin electrocution position and a vermin discarding position;
an ingress in the housing to enable vermin access to the interior path;
a bait retention device adapted to receive bait, the bait retention device spaced from the ingress so as to attract vermin to proceed along the interior path to the in-line rotatable passage;
wherein the in-line rotatable passage comprises an electrocution surface spaced apart from an opening, such that the electrocution surface is disposed upwardly when the passage is in the vermin electrocution position and the opening is disposed downwardly when the passage is in the vermin discarding position, the electrocution surface comprising one or more areas wired for passage of electrical current;
a carcass disposal region disposed below the in-line rotatable passage; and
a sensor adjacent the electrocution surface and adapted to detect a presence of a vermin and to send a vermin detection signal to a control apparatus upon detecting the presence of the vermin;
the control apparatus adapted to (i) electrify the electrocution surface in response to receiving the vermin detection signal so that electrical current is passed through the vermin to kill the vermin, and (ii) subsequently actuate rotation of the in-line rotatable passage from the vermin electrocution position to the vermin discarding position to drop the vermin through the opening into the carcass disposal region.

17. The apparatus of claim 16, further comprising a one-way door adjacent the in-line rotatable passage that requires the vermin to pass through the one-way door to access the in-line rotatable passage, wherein the one-way door comprises a plurality of apertures adapted to disperse bait scent therethrough.
